(19) United States
(12) Patent Application Publication
(10) Pub. No.: US 2026/0084370 A1
(43) Pub. Date: Mar. 26, 2026

(54) TENSION CONTROL FOR PIPELINE REMEDIATION

(71) Applicant: BRAINDRIP, LLC, JACKSONVILLE, FL (US)

(72) Inventors: Kent Weisenberg, Jacksonville, FL (US); Corbin Tremblay, Jacksonville, FL (US); Daniel Sawyer, Riverview, FL (US); Tyler Husko, Jacksonville, FL (US)

(73) Assignee: BRAINDRIP, LLC, JACKSONVILLE, FL (US)

(21) Appl. No.: 19/302,780

(22) Filed: Aug. 18, 2025

Related U.S. Application Data
(60) Provisional application No. 63/699,348, filed on Sep. 26, 2024.

(51) Int. Cl. B29C 63/00; B29C 63/34

(52) U.S. Cl. CPC B29C 63/0004; B29C 63/0052; B29C 63/34

(57) ABSTRACT

A system and method for efficiently inserting pull-in-place lining systems into an existing pipeline are provided. The system and method compensate for the effect of tension in an insert as the insert is being pulled through the pipeline. Specifically, the degree of sag of a portion of the insert in a sag zone is determined from data provided by one or more proximity sensors positioned adjacent the insert as the insert is advanced downstream along a feed path. The speed of the advancing of the insert is adjusted based on the determined degree of sag and a predetermined optimal sag range.

### CROSS REFERENCE TO RELATED APPLICATIONS

This application claims priority to U.S. Provisional Patent Application Ser. No. 63/699,348, filed on Sep. 26, 2024, and titled “Tension Control for Pipeline Remediation,” the disclosure of which is incorporated herein by reference.

### FIELD

Disclosed herein are methods and related manufactures for efficiently inserting pull-in-place lining systems into an existing pipeline. The methods compensate for the effect on tension in an on-site manufactured insert caused by external forces on the insert, including, but not limited to, frictional and gravitational forces due to the existing pipeline.

### BACKGROUND

Existing bare steel pipelines present significant risks to owners since pipelines are not coated and will not have the long-term integrity and lifespan of modern-day pipelines. These pipelines are more prone to develop leaks from corrosion, defect rupture or experience disruptions due to leaks. Steel and cast/ductile iron distribution systems are generally extremely old and represent significant risks for owners and operators. Most of these systems do not comply with the Gas Modernization Act and will require replacement, rehabilitation, or renewal.

Aging pipelines continue to plague the industry, for example, TETCO has issued well over 400 notices of replacement or repair since 2019. Due to replacement and repair, summer maintenance has now started affecting the ability of producers to transport to key markets for power and LNG, meaning pipelines are no longer just seasonal, they are under year-round stress. Furthermore, many of the natural gas pipelines currently in operation will need to possess and maintain integrity for their use for the transmission of hydrogen diluted media and high purity hydrogen in the future. It is estimated that 80% of the existing natural gas pipelines do not possess the structural integrity or composition required to resist hydrogen embrittlement, or to resist rupture with the increase in internal pressure or the cyclic pressure variations resulting from hydrogen-based transmission. These pipelines will need either replacement or renewal prior to hydrogen composition media conversion.

There are currently known compositions for pull-in-place internal lining systems that provide improved properties and/or repair degraded or damaged pipelines already in use. These lining systems are most closely related to certain methods and manufactures disclosed herein, and comprise linings made from unreinforced, reinforced high-density polyethylene (HDPE), fiber reinforced polymer pipe (FRP) or remotely spray or cast applied linings (SIPP).

These internal lining systems can consist of a pipe insert (“insert” for short), which consists of a pipe whose outer diameter is no larger than the inner diameter of the pipeline undergoing remediation. The insert is pulled through the interior of the pipeline, using, e.g., a winch at an end of the pipeline. Once appointed throughout the entire length of the pipeline, the interior surface of the insert will serve as the new interior volume of the pipeline.

Preferably, the insert is non-rigid in order to accommodate twists and turns in the pipeline during installation. It will be understood that lengths of pipelines that were originally intended to be straight can, over time, undergo deformation due to settling and to application of external forces. For this and other reasons, both the flexibility of the insert and its outer diameter, relative to the inner diameter of the pipeline, are important design considerations that can vary from site to site.

Typically, these inserts are delivered to the jobsite in 40 ft. long sections and, depending on the diameter, require between 18 and 400 roundtrip trucking events per one mile of installation. These inserts are typically limited to 40 ft. in length due to over-the-road shipping restrictions.

Many of these pull-in-place installations are completed in environmentally sensitive areas, such as nature preserves, under rivers, lakes, oceans, or protected wetlands, which significantly increases the impact of a smoothly running remediation operation, let alone the impact caused by failure of such an operation. For at least this reason, it is critical that installation of the pull-in-place liner be as risk-free as possible, while still providing an effective remediation to the pipeline.

Techniques for pipeline remediation are being developed that offer on-site manufacture of the insert. These techniques circumvent the need to transport individual sections to the remediation site. For this reason, many of the problems associated with transport can be avoided. In particular, the length of the insert is no longer limited by the requirements of ground transport. Instead, extended sections of insert, each substantially longer than the 40 ft. segments used in conventional methods, can be employed.

In order to avoid the need to store the insert post-manufacture and pre-insertion, the remediation method will preferably manufacture the insert concurrently with appointment of the insert. In this mode, the leading edge of the insert will be fed into one end of the pipeline, termed the “upstream” end. As the insert is manufactured, behind the leading edge, it is simultaneously pulled into the pipeline with a winch located at the other end of the pipeline, termed the “downstream”end.

One benefit from the use of longer sections of insert will be immediately apparent: longer sections require fewer connections between adjacent sections, thereby reducing both the mechanical complexity and the number of connections, each of which being a potential vulnerable site in the overall insert.

A challenge with the use of longer sections of insert is the requirement to pull these sections through extended runs of steel pipeline. The interior surface of the pipeline will retard the forward motion, thereby requiring a significant pulling force for insertion of the insert.

In principle, shorter sections can be pulled sequentially into place in a pipeline, thereby avoiding difficulties caused by the use of lengthier sections. However, insertion of individual sections sequentially into the pipeline would require subsequent joining of adjacent sections while located within the pipeline, which may be difficult to achieve. In practice, therefore, even methods that employ shorter sections of insert may call for pre-joining of the sections prior to insertion into the pipeline. These methods would then be vulnerable to the same effects due to the large pulling force required for a single longer insert.

The force moving the insert down the pipeline will generate tension in the insert. This tension will decrease from the downstream end, i.e. the winch end, to the upstream end, i.e. the supply of insert. The tension in the section of the insert that is upstream of the pipeline, and therefore unaffected by friction with the pipeline, can be even smaller.

The pulling speed, i.e. the speed with which the insert is pulled down the pipeline, by a winch or an alternative mechanism, should match the supply speed, i.e. the speed with which the insert is supplied at the upstream end. If the pulling speed is slower than the supply speed, the insert will tend to sag or bunch where possible, or compress longitudinally if not possible. Conversely, if the pulling speed is faster than the supply speed, the insert will undergo longitudinal stretching, at best, or rupture, at worst.

For these and other reasons, there remains a need for methods for appointing inserts in pipelines that provide sufficient monitoring and control of tension in order to improve the reliability of the pipeline remediation process.

### BRIEF SUMMARY

Provided herein is a method for appointing a flexible insert into a pipeline. The insert may be manufactured onsite, or alternatively it may be provided in a pre-fabricated state. In either case, the insert is fed into the upstream end of the pipeline, and pulled downstream through the pipeline. The pulling speed, or the supply speed, or both, may be variable.

In an embodiment, the insert is allowed to traverse in a zone between the exit of the onsite factory and the upstream opening of the pipeline without external support for the weight of the insert. In this zone, termed the “sag zone”, the insert is supported solely by its longitudinal tension, and, depending on the tension in the insert, is allowed to sag from vertical.

This sag zone provides a buffer to periodic mismatches in upstream supply speed and downstream pulling speed. In the event the supply speed increases above the pulling speed, the insert within the sag zone, termed the “insert segment” will simply form a larger downward sag with the accumulated slack. Conversely, if the supply speed decreases below the pulling speed, the downward sag will decrease in magnitude, as the slack is taken up.

Excessive downward sag can potentially cause the insert to be abraded by the ground, or lead to distortion of its geometry on entrance into the pipeline. Conversely, insufficient sag in the insert will make it vulnerable to even small mismatches in supply speed and pulling speed. In general, the insert will have low elasticity in the lengthwise dimension, and a surge at the winch end or holdup at the manufacture end can cause the insert to abruptly pull taut. Although the insert is manufactured for strength and resilience in the lateral direction, an abrupt increase in tension in the insert can cause fatigue or damage. In extreme cases, for example, the appointment of extremely long inserts, which will be accompanied by a large gradient in tension down the insert, a sudden tug on the insert could potentially lead to a tear or break. At very least, such an event might require a halt in manufacture to inspect for damage.

Also provided, therefore, is a method for monitoring the degree of sag, and correcting either of the supply speed and the pulling speed, or both. During the process of appointing the insert, the sag in the sag zone is monitored, thereby providing a real-time estimation of any variation in tension in the insert. This variation may be caused by any one of a number of phenomena, including but not limited to a mismatch in delivery speed at the upstream end and pulling speed in the pipeline.

Data from the degree of sag will be processed in real time, and will be used to control the feed of the insert, either at the upstream end, or the downstream end, or both. Optionally, the lateral sway in the insert, i.e. horizontal deflection from the sag zone centerline, will be monitored as well, at least to correct for any apparent vertical deflection of the insert caused by “jump-rope” motion of the insert.

### BRIEF DESCRIPTION OF THE DRAWINGS

A full understanding of the invention can be gained from the following description of the preferred embodiments when read in conjunction with the accompanying drawings in which:

FIGS. 1A, 1B and 1C depict schematics of a suspended catenary insert that is taut, with sag that is less than the minimum optimal sag, and with sag that is greater than the maximum optimal sag, respectively;

FIGS. 2A and 2B depicts a perspective of the sag zone concept, according to an embodiment. that is insert taut and insert with sag, respectively;

FIGS. 3A and 3B depict a horizontal projection of the sag zone concept, according to an embodiment, that is insert taut and insert with sag, respectively;

FIGS. 4A, 4B, and 4C depict a cross-section of an insert and proximity sensors, with the insert neutral, high, and low, respectively;

FIG. 5A. 5B, and 5C depict a cross-section of an insert and proximity sensors, with the insert neutral, left, and right, respectively;

FIGS. 6A and 6B depict a cross-section of an insert and widely spaced proximity sensors, with the insert neutral and high, respectively;

FIGS. 7A and 7B depict a cross-section of an insert and narrowly spaced proximity sensors, with the insert neutral and right, respectively;

FIGS. 8A and 8B depict a cross-section of an insert and proximity sensors, with the insert neutral and right, respectively;

FIGS. 9A and 9B depict a cross-section of an insert and proximity sensors, with the insert neutral and high, respectively;

FIGS. 10A and 10B depict an embodiment of the disclosed concept that includes a sensor assembly in perspective and horizontal projection, respectively; and

FIGS. 11A and 11B depict an embodiment of a sensor assembly forming a part of the system of the disclosed concept in perspective and horizontal projection, respectively.

### DETAILED DESCRIPTION OF EXEMPLARY EMBODIMENTS

Accordingly, provided herein, in an exemplary embodiment, is a method for appointing a flexible insert into a pipeline, the pipeline having an upstream opening, a downstream opening, and an interior, the method comprising the steps of:
providing an onsite factory comprising a forming mandrel for forming tubular inserts at or near the upstream opening of the pipeline, such that:
   a sag zone is formed between the onsite factory and the upstream opening of the pipeline, and
   a feed path is formed between the onsite factory and the downstream opening of the pipeline;
positioning one or more proximity sensors on or near an apparatus centerline joining the exit of the onsite factory and the upstream opening of the pipeline;
forming a leading end for the insert in the onsite factory;
initiating manufacture of the insert in the onsite factory behind the leading end;
inserting the leading end for the insert into the upstream opening of the pipeline, thereby forming an insert segment in the sag zone;
advancing the leading end downstream in the interior of the pipeline, thereby advancing the insert downstream along the feed path behind the leading end; and
during manufacture of the insert:
   determining the degree of sag of the insert segment from data provided by the one or more proximity sensors as the insert is moved downstream along the feed path, and
   adjusting the downstream linear speed of the insert, so as to maintain the sag in the insert segment within an optimal range.

In some embodiments, the apparatus centerline is substantially coplanar with a vertical plane containing the centerline of the forming mandrel. In some embodiments, the apparatus centerline is substantially collinear with the centerline of the forming mandrel.

In some embodiments, the apparatus centerline is substantially coplanar with a vertical plane containing the centerline of the pipeline near the upstream opening. In some embodiments, the apparatus centerline is substantially collinear with the centerline of the pipeline near the upstream opening.

In some embodiments, the exit of the onsite factory is substantially perpendicular to the apparatus centerline. In some embodiments, the upstream opening of the pipeline is substantially perpendicular to the apparatus centerline.

In some embodiments, the insert is advanced downstream with a line comprising a first end and a second end. In some embodiments, the first end of the line is attached to the leading edge of the insert. In some embodiments, the method further comprises the step of attaching the leading edge of the insert to the first end of the line. In some embodiments, the line is connected to a winch located at the downstream end of the pipeline. In some embodiments, the winding speed of the winch is adjustable. In some embodiments, the winding axis of the winch is substantially perpendicular to the centerline of the pipeline near the downstream end.

In some embodiments, the method further comprises the step of connecting the winch to the second end of the line. In some embodiments, the method further comprises the step of threading the line through the pipeline.

In some embodiments, the degree of sag of the insert segment is determined with one or more proximity sensors located in or near the sag zone. In some embodiments, the one or more proximity sensors is positioned at a level below the exit of the onsite factory. In some embodiments, the one or more proximity sensors is positioned below the insert segment. In some embodiments, the one or more proximity sensors is positioned at or astride the insert segment at a point midway between the exit of the onsite factory and the upstream opening of the pipeline.

In some embodiments, the one or more proximity sensors comprise a central proximity sensor located on the apparatus centerline. In some embodiments, the central proximity sensor is configured to determine a distance to an object positioned above the one or more proximity sensors on the apparatus centerline in a direction that is substantially vertical. In some embodiments, the object is a horizontal cylinder. In some embodiments, the centerline of the horizontal cylinder is coplanar with a vertical plane containing the apparatus centerline.

In some embodiments, the one or more proximity sensors comprise one or more peripheral proximity sensors located off the apparatus centerline.

In some embodiments, the one or more proximity sensors comprise a plurality of proximity sensors. In some embodiments, plurality of proximity sensors comprises a central proximity sensor and one or more peripheral proximity sensors.

In some embodiments, each of the plurality of proximity sensors is configured to detect distance in a vertical direction or in a direction canted upward from horizontal.

In some embodiments, the one or more proximity sensors comprise a plurality of coplanar proximity sensors. In some embodiments, the plurality of proximity sensors comprises a central proximity sensor, which is flanked by an equal number of coplanar peripheral proximity sensors. In some embodiments, the plurality of proximity sensors is substantially coplanar with a plane whose normal is parallel to the apparatus centerline. In some embodiments, the plurality of proximity sensors is substantially coplanar with a plane whose normal is parallel to the centerline of the mandrel. In some embodiments, the plurality of proximity sensors is substantially coplanar with a plane whose normal is parallel to the exit of the onsite factory. In some embodiments, the plurality of proximity sensors is substantially coplanar with a plane whose normal is parallel to the normal to the upstream opening of the pipeline.

In some embodiments, the one or more proximity sensors comprise a plurality of proximity sensors, each of which is located on a horizontal line collinear with all of the proximity sensors. In some embodiments, the plurality of proximity sensors comprises a central proximity sensor, which is flanked by an equal number of peripheral proximity sensors on either side of the horizontal line. In some embodiments, the horizontal line is perpendicular to the apparatus centerline. In some embodiments, the horizontal line is perpendicular to the centerline of the mandrel. In some embodiments, the horizontal line is perpendicular to the normal to the exit of the onsite factory. In some embodiments, the horizontal line is perpendicular to the normal to the upstream opening of the pipeline.

In some embodiments:
the central proximity sensor is configured to determine a distance to an object positioned above the one or more proximity sensors on the apparatus centerline in a direction that is substantially vertical; and
the one or more peripheral proximity sensors are each configured to determine a distance in a direction that is canted inward from vertical, towards a vertical line containing the central proximity sensor, with the degree of cant being larger for proximity sensors that are positioned farther out from the central proximity sensor.

In some embodiments, the one or more proximity sensors are configured to determine a distance to an object positioned above the one or more proximity sensors on the apparatus centerline. In some embodiments, the object is a cylinder. In some embodiments, the one or more proximity sensors comprises a plurality of proximity sensors, each of which is substantially coplanar with a plane whose normal is parallel to the centerline of the cylinder. In some embodiments, the one or more proximity sensors comprise a plurality of proximity sensors, each of which is located on a horizontal line collinear with the remaining proximity sensors and perpendicular to the centerline of the cylinder.

In some embodiments, the one or more proximity sensors comprise:
a central proximity sensor located on the apparatus centerline; and
a first pair of proximity sensors, located laterally outward from the apparatus centerline; wherein
each of the first pair of peripheral proximity sensors is configured to determine a distance to the insert segment, in a direction canted inward from vertical.

In some embodiments, the central proximity sensor and each of the first pair of peripheral proximity sensors are substantially coplanar with a plane whose normal is parallel to the apparatus centerline. In some embodiments, the central proximity sensor and each of the first pair of peripheral proximity sensors are substantially collinear with a horizontal line that is perpendicular to the apparatus centerline. In some embodiments, each of the first pair of peripheral proximity sensors is substantially the same distance from the central proximity sensor.

In some embodiments, the one or more proximity sensors comprise:
a central proximity sensor located on the apparatus centerline; and
a first pair of proximity sensors, located laterally outward from the apparatus centerline; and
a second pair of proximity sensors, located laterally outward from the apparatus centerline; wherein
each of the first pair of peripheral proximity sensors is configured to determine a distance to the insert segment, in a direction canted inward from vertical; and
each of the second pair of peripheral proximity sensors is configured to determine a distance to the insert segment, in a direction canted inward from vertical.

In some embodiments, the central proximity sensor, each of the first pair of peripheral proximity sensors, and each of the second pair of peripheral proximity sensors are substantially coplanar with a plane whose normal is parallel to the apparatus centerline. In some embodiments, the central proximity sensor, each of the first pair of peripheral proximity sensors, and each of the second pair of peripheral proximity sensors are substantially collinear with a horizontal line that is perpendicular to the apparatus centerline.

In some embodiments, each of the one or more proximity sensors is configured to determine a distance to the insert segment. In some embodiments, at least one of the one or more proximity sensors is configured to determine a distance to the insert segment in a direction that is substantially vertical. In some embodiments, at least one of the one or more proximity sensors is configured to determine a distance to the insert segment in a direction canted laterally from vertical.

In some embodiments, the one or more proximity sensors monitors the degree of vertical sag in the insert segment. In some embodiments, the one or more proximity sensors monitors the degree of lateral sway in the insert segment. In some embodiments, data provided by the one or more proximity sensors can provide the magnitude of sag in the insert segment. In some embodiments, data provided by the one or more proximity sensors can provide the magnitude of sway in the insert segment.

In some embodiments, the optimal range for the sag in the insert segment comprises lower and upper optimal limits on sag.

In some embodiments, both the lower and the upper optimal limits on sag at any point in time are dependent on the magnitude of lateral sway of the insert segment at that point in time.

In some embodiments, during manufacture of the insert, the linear speed of advancement of the leading end is continuously adjusted, thereby maintaining the sag of the insert segment within its optimal range. In some embodiments, the average linear speed of advancement is between 6 feet/min and 12 feet/min, inclusive.

In some embodiments, during manufacture of the insert, upon detection that the sag is below its lower optimal limit, the pulling speed is increased until the sag rises to a position above its lower optimal limit.

In some embodiments, during manufacture of the insert, upon detection that the sag is above its upper optimal limit, the pulling speed is decreased until the sag descends to a position below its upper optimal limit.

In some embodiments, the one or more proximity sensors are provided by a sensor array, which comprises:
a support structure configured for positioning on a horizontal surface; and
one or more proximity sensors mounted on the support structure, each configured to determine, on positioning the support structure on a horizontal surface, a distance to the object positioned above the support structure.

In some embodiments, the sensor array comprises a central proximity sensor configured to determine a distance to the object in a direction that is substantially vertical.

Also provided herein, in an exemplary embodiment, is an apparatus for appointing a flexible insert into a pipeline, the apparatus comprising:
an onsite factory;
a sensor assembly as disclosed herein; and
a means for advancing an insert down a pipeline.

Also provided herein, in an exemplary embodiment, is an apparatus for appointing a flexible insert into a pipeline, the apparatus comprising:
an onsite factory;
a sensor assembly as disclosed herein;
a variable speed winch.

In some embodiments, the apparatus further comprises a line comprising two ends. In some embodiments, the apparatus further comprises a control system configured to receive distance data from the one or more proximity sensors. In some embodiments, the control system is further configured to control the speed of the variable speed winch, based on the input from the one or more proximity sensors.

Also provided are embodiments wherein any embodiment above may be combined with any one or more of these embodiments, provided the combination is not mutually exclusive

### Definitions

As used herein, the directions “upstream” and “downstream” refer to directions toward the onsite factory and toward the winch, respectively. The nascent insert will be pulled with the winch in a downstream direction.

As used herein, alone or in combination, the term “insert” refers to a hollow cylindrical article of manufacture. The dimensions of the insert are without limitation; however, the term is generally used for a cylinder whose outer diameter is no larger than inner diameter of a pipeline in need of remediation. The insert is therefore suitably sized for appointment in the interior of a pipeline in need of remediation. The insert is generally sufficiently flexible to allow placement into position within a pipeline that is not perfectly straight. The insert has sufficient strength in the longitudinal direction to allow it to be pulled into the interior of a pipeline without significant risk of tear or rupture. The insert may comprise a plurality of layers. Optional layers include an external layer that preferably resists abrasion caused by contact with the inner surface of the pipeline. Other optional layers include an axial reinforcement layer and a hoop reinforcement layer. Other optional layers further include sensor array layers. Preferably, the insert comprises an innermost layer that will provide a leakproof seal, thereby affording the desired remediating property for the insert.

As used herein, alone or in combination, the term “onsite factory” refers to a piece of equipment for providing an insert. Although the methods and articles of manufacture described herein generally contemplate that the insert be manufactured at the site of remediation, it is envisioned that the concepts disclosed herein would be valuable to methods of pipeline remediation that utilize pre-manufactured inserts conveyed to a site and appointed without further manufacture. The concepts may be particularly valuable for onsite manufacture, since the extreme lengths of insert made possible by onsite manufacture are particularly vulnerable to inadequate compensation for tension, both due to the variation in tension that would be expected for longer inserts, and due to the higher cost and disruption that might be caused by failure to adequately and reliably manage tension variation. In the extreme, a failure may cause either long-term issues, such as premature fatigue of the insert, or short-term issues, such as physical tears in the insert material.

Onsite factories for the manufacture of long stretches of insert will feature several innovations, including most prominently a cantilevered forming mandrel, on which successive layers of material are applied to the nascent insert. The onsite factory will manufacture the insert in a progressive fashion, i.e., once manufacture is initiated by formation of a leading end, generally cylindrical in nature, the insert is manufactured behind the leading end by applying material onto the cylindrical mandrel, and slipping the nascent insert off the cantilevered end of the mandrel as it is extended.

As it is formed, the insert is supported internally by the mandrel. External supports, such as rollers, can be utilized as needed, including but not limited to the cantilevered end of the mandrel. Depending on the length of the mandrel, the weight of the nascent insert, and the external forces applied to the insert, the rollers can be positioned to reduce the bending moment that would otherwise be applied to the mandrel.

Manufacture of the insert in the onsite factory generally proceeds from the inner surface of the insert outward, and can be initiated by forming an inner sealing layer, which can be applied from sheet stock onto the mandrel at the upstream end, followed by longitudinal sealing to form the innermost cylindrical layer. Successive layers can be applied, from spools of material mounted in the onsite factory, onto the innermost cylindrical layer, in either a longitudinal or a helical direction. The technology allows for inclusion of a variety of layers into the insert, including sensor wires for monitoring the health of the insert and an outermost protective layer for facilitating appointment of the insert into the pipeline.

Exemplary onsite factories are disclosed in US Patent Application Publications US20220143948(A1) and US20220412511(A1), the disclosures of both of which are incorporated herein by reference.

As used herein, alone or in combination, the term “exit” refers to farthest downstream point in the onsite factory at which the weight of the insert is mechanically supported. Downstream of the exit, the insert will be unencumbered from sagging downward from horizontal. In some embodiments, the exit corresponds to the downstream end of the mandrel (interior to the insert), or rollers for supporting the insert and/or pulling it downstream (exterior to the insert), or both. The exit need not have a circular geometry; however, the mandrel will preferably have a circular cross-section. Likewise, pulling/supporting rollers at the downstream end of the onsite factory will also preferably be positioned in a ring around the nascent insert.

A device will generally be located at the exit for pulling the nascent insert along the mandrel. The alternative, i.e., a device at the upstream terminus of the onsite factory that pushes the nascent insert along the mandrel, is less likely but is within the scope of this disclosure.

At points upstream from the exit, the insert is supported by one or more mechanisms, including but not limited to a cantilevered forming mandrel interior to the insert, and rollers exterior to the insert. At points downstream to the exit, the insert is supported primarily or solely by the longitudinal tension within the insert.

As used herein, alone or in combination, the term “sag zone” refers to a region between the exit of the onsite factory and the upstream opening of the pipeline undergoing remediation. When advancing from the onsite factory to the pipeline, the insert will be contained within the sag zone. When viewed from above, in the absence of lateral forces, the insert within the sag zone will be linear. The sag zone can therefore be conveniently characterized by its centerline. The pulling/supporting rollers at both the exit of the onsite factory and at the upstream opening to the pipeline define the geometry of the insert in this region; therefore, the sag zone can be defined in the absence of an insert.

The sensor array is generally located in the sag zone, at a position underneath the pipeline, at or near the sag zone centerline.

In some embodiments, one or both of the pulling/supporting rollers at either end of the sag zone, and/or the sensor array, are provided in an apparatus that positions these components properly for the intended method. In some embodiments, either or both of the pulling/supporting rollers and/or the sensor array are positioned onsite.

As used herein, alone or in combination, the term “insert segment” refers to the portion of the insert located, at a given point in time, within the sag zone. The insert segment therefore represents a snapshot of the insert between the factory exit and the pipeline's upstream entrance, at a particular point in time.

As used herein, alone or in combination, the term “feed path” refers to a path along which the insert travels, from the point of manufacture in the onsite factory, and through the length of the sag zone. Upstream of the pipeline, the feed path is equivalent to the sag zone, and can therefore generally be defined in the absence of an insert. In the presence of a pipeline undergoing remediation, the feed path continues into the upstream opening of the pipeline and downstream in the pipeline, and to the downstream opening.

As it is progressively manufactured, the insert will pass from the exit of the onsite factory to the upstream opening of the pipeline, through the sag zone. At any point of time, the weight of the insert segment is externally supported only at its two ends. In the absence of external force, the insert segment would be collinear with the sag zone centerline. Due to its weight and lack of support in the sag zone, the insert segment will sag downward from the sag zone centerline, with the degree of sag depending on the tension in the insert segment. Horizontal forces acting on the insert segment may also deflect it laterally from the sag zone centerline. Finally, the insert segment may develop a periodic sway, resembling a jump-rope type motion in the sag zone.

Preferably, both the exit, at the upstream end of the sag zone, and the upstream opening of the pipeline, at the downstream end of the sag zone, will be oriented so that the insert will pass from the onsite factory to the pipeline with a minimum of contact with either the exit and the upstream opening, so as to minimize wear and tear on the insert caused by excessive friction.

Optionally, horizontal and/or vertical rollers can be provided at either or both ends of the sag zone, in order to guide the insert along the desired path with a minimum of friction.

Preferably, the apparatus centerline is coplanar with a vertical plane containing the centerlines of both the onsite factory and the pipeline at its upstream opening. This geometry will permit the insert to pass from the onsite factory, through the sag zone, and into the pipeline without the need for lateral redirection of the insert.

The desired sag in the insert will necessarily distort its geometry away from perfectly horizontal. Also, remediation of a subterranean pipeline with an insert manufactured by an aboveground onsite factory may hinder perfect vertical alignment of the insert. For these reasons, lateral rollers at either end of the sag zone may be employed to guide the insert with a minimum of friction from the onsite factory, through the sag zone, and into the pipeline.

Tension at the upstream end of the insert segment within the sag zone is provided by the various machinery within the onsite factory responsible for manufacturing the insert. Tension at the downstream end of the insert segment within the sag zone is provided by the winch at the downstream end of the pipeline, potentially attenuated by, inter alia, frictional forces within the pipeline.

In the absence of either exterior support of the insert, or infinite tension within the insert, the flexible insert segment within the sag zone will undergo the process suggested by its name, i.e., it will sag. The geometry of an ideal insert segment will resemble a catenary. The particular geometry of a nonideal insert segment is unimportant; it is sufficient to appreciate that, the smaller the tension in the insert segment, the lower the segment will sag from horizontal.

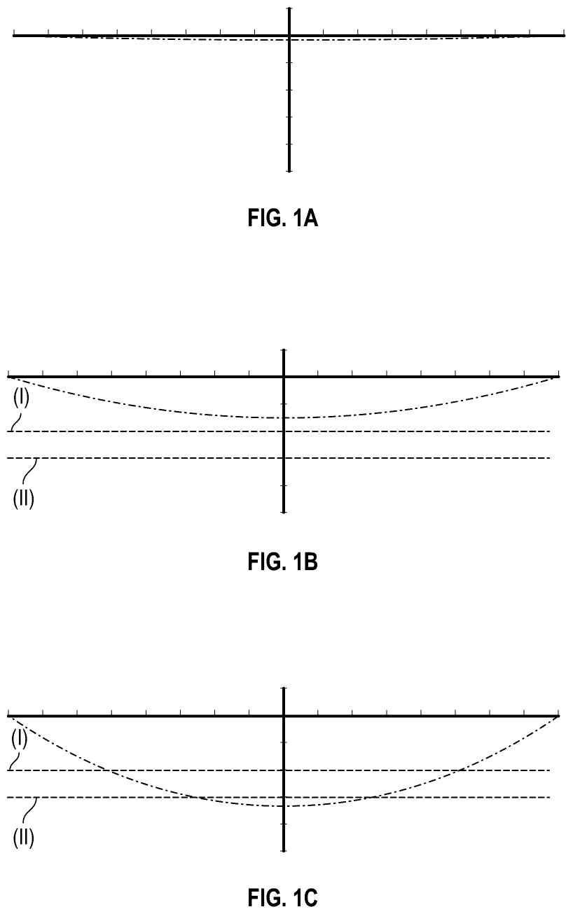

The effect of tension on sag is depicted in FIGS. 1A-1C. A rope, either solid or hollow, having a finite mass and nonzero lengthwise elasticity, and supported only at either end, will be devoid from sag only under either of two conditions: zero gravity or infinite tension. In any other condition, the weight of the rope will pull downward on the cord and induce a sag from horizontal. A schematic of such a rope is depicted in FIG. 1A.

The methods disclosed herein employ the degree of sag to monitor the tension in an insert by measuring the degree of sag. For optimal manufacture, tension will be uniform. If this is not possible, tension should be confined to a narrow range: sufficiently low so as not to risk damage to the insert, but sufficiently high to pull the insert into the pipeline at a reasonable speed. Depending on the desired range of tension, and the composition of the insert, minimum and maximum sags can be calculated, and are indicated as (i) and (ii), respectively, in FIGS. 1B and 1C.

FIG. 1B depicts a condition in which tension is higher than the optimal range. An increase of tension beyond the optimal maximum will pull the insert segment more taut than usual, making the sag less than the optimal minimum sag, and elevating the insert segment above the optimal range, i.e., above (i) as shown in FIG. 1B.

FIG. 1C depicts a condition in which tension is lower than the optimal range. The decrease of tension below the optimal minimum will allow more slack into the insert than usual, making the sag greater than the optimal maximum sag, and lowering the insert segment below the optimal range, i.e., below (ii) as shown in FIG. 1C.

In an embodiment, the degree of sag is monitored by one or more proximity sensors located in or near the sag zone as described herein. Optionally, light source optical sensor pairs comprising the proximity sensors, located on opposite sides of the sag zone, are configured to determine the height of the insert at various locations, due to blockage of the light path by the insert.

Each of the proximity sensors can use ultrasonic or optical methods to directly measure the height of the insert. A variety of sensor technologies can be employed for the methods disclosed herein. Sensors can utilize electromagnetic radiation, both within the visible light spectrum and outside, e.g. ultraviolet, infrared, and longer wavelengths, including microwave and radio regions of the spectrum. Light sources can be coherent or incoherent. Distance determination can include, without limitation, pulse, time of flight, and frequency modulation techniques. Similarly, audible or ultrasonic sound can be employed. Alternatively, distance measurement can use an alternative physical phenomenon, such as induction, capacitance, and magnetism.

Distance measurement may be enhanced with 3D mapping, which may be particularly useful for inserts with larger cross-sections.

In conjunction with measuring the degree of sag and sway, the sensors can also be employed to detect variation in the geometry of the insert, particularly the diameter. In some embodiments, an excursion from an acceptable diameter range can trigger an error condition or interrupt the manufacturing process.

The types of proximity sensors that can be employed include, but are not limited to, inductive proximity sensors, capacitive proximity sensors, ultrasonic proximity sensors, photoelectric proximity sensors, magnetic proximity sensors, laser proximity sensors, infrared proximity sensors, time of flight sensors, and fiber optic proximity sensors.

Preferentially, the transverse position of the insert will also be monitored. In the absence of external forces, the sag in the insert will be directed vertically downward, and the entire insert within the sag zone will be contained in a vertical plane. Horizontal forces, such as those caused by wind, may introduce a lateral sway in the insert. This deflection by the insert from vertical would distort a tension estimation based solely on vertical sag. Furthermore, a single discrete application of horizontal force may induce a periodic “jump-rope” motion in the insert. In the absence of monitoring of transverse position, this motion could be incorrectly interpreted as a vertical oscillation in the insert.

In some embodiments, the method employs guides to constrain significant displacements beyond that of the neutral state, defined simply as a state with uniform and constant tension within the insert segment, and in the absence of exterior forces. These guides may constrain lateral motion, which may be particularly valuable in the presence of significant external lateral forces, including wind. These guides may provide rollers or similar mechanisms to allow downstream motion to proceed relatively unhindered, while still constraining the position of the insert segment.

In an embodiment, the one or more proximity sensors comprise three proximity sensors located below the level of the insert segment. Each of the proximity sensors will measure the distance to the insert by projecting a beam onto the surface of the insert. Preferentially, the three proximity sensors are arranged in a line perpendicular to the centerline of the insert. Alternatively, the three proximity sensors can be arranged in a plane whose normal is parallel to the centerline of the insert. The set will therefore consist of a central proximity sensor flanked by two inner peripheral proximity sensors, each offset from the centerline. The central proximity sensor will preferentially be directed upward, so as to measure the height of the insert. The inner peripheral proximity sensors will preferentially be canted inward, and the distance reported by each of the inner peripheral proximity sensors will therefore include both horizontal and vertical components. The output from the three proximity sensors will be processed, in real time, to provide data on both vertical sag and horizontal deflection.

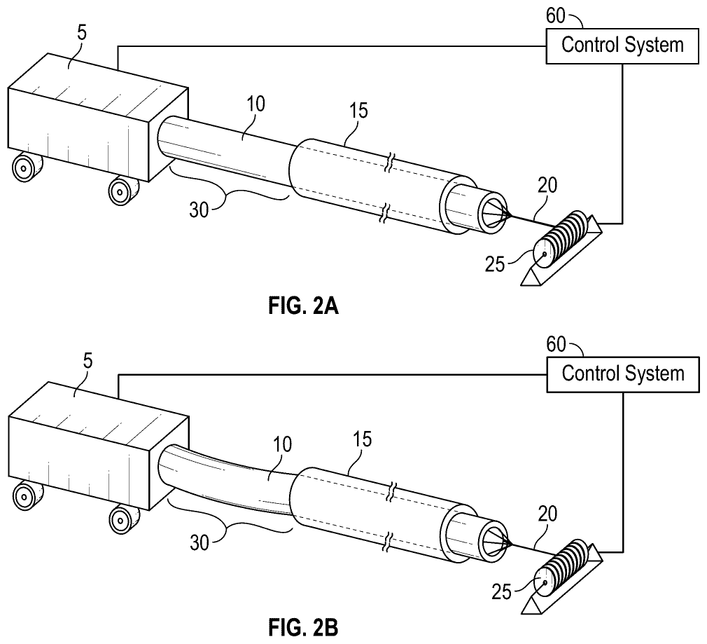

Depicted in FIGS. 2A and 2B is an embodiment of the manufacturing process/system of the disclosed concept. Onsite factory 5 for manufacturing insert 10 is shown schematically as a rectangular prism on wheels, with nascent insert 10 emerging from onsite factory 5 to the right. In this depiction, “upstream” is to the left, and “downstream” is to the right. The pipeline 15 undergoing remediation is shown as hollow cylinder, with indefinite length. Line 20 is attached on a first end to insert 10 and on a second end to winch 25.

The winch 25 and onsite factory 5 are coupled to a control system 60. Control system 60 is also coupled to each of the proximity sensors 35, 40, 45 as described and shown herein to receive the distance data measured by the proximity sensors. Control system 60 comprises a programmable analog and/or digital device (including an associated memory part or portion) that can store, retrieve, execute and process data (e.g., software routines and/or information used by such routines), including, without limitation, a field programmable gate array (FPGA), a complex programmable logic device (CPLD), a programmable system on a chip (PSOC), an application specific integrated circuit (ASIC), a microprocessor, a microcontroller, a programmable logic controller, or any other suitable processing device or apparatus. The memory portion can be any one or more of a variety of types of internal and/or external storage media such as, without limitation, RAM, ROM, EPROM(s), EEPROM(s), FLASH, and the like that provide a storage register, i.e., a non-transitory machine readable medium, for data and program code storage such as in the fashion of an internal storage area of a computer, and can be volatile memory or nonvolatile memory. The program code is configured to receive the distance data from the proximity sensors, calculate the degree of sag and/or sway of insert segment 30 based on the received distance data (using any suitable geometric technique or calculation), and to control the supply speed of onsite factory 5 and/or the pulling speed of winch 25 using a feedback loop based on the calculated sag and/or sway to control the sag and/or sway such that they are within predetermined ranges or limits as described herein.

In one particular embodiment, control system 60 implements the closed loop feedback described above, wherein the speed of the advancing of the insert 10 (i.e., the supply speed of onsite factory 5 and/or the pulling speed of winch 25) is controlled to control the sag and/or sway such that they are within predetermined ranges or limits, using an appropriate closed feedback system/algorithm, such a Proportional-Integral-Derivative (PID) Controller, a Proportional-Integral (PI) Controller, a Proportional-Derivative (PD) Controller, a Cascade Controller, a Feed-Forward Controller, a Model Predictive Control (MPC), or a combination of two or more thereof.

At any point in time, insert segment 30 is located in the sag zone, which is the zone between onsite factory 5 (to the left_ and pipeline 15 (to the right). In this embodiment, insert segment 30 is supported only at its two termini.

FIG. 2A depicts a condition of relatively high tension, corresponding to relatively low sag. In order to alleviate the high tension, a proper response would be to either reduce the speed at which insert 10 is being pulled through pipeline 15, or to increase the speed of fabrication at the onsite factory 5 via control system 60. Either action would reduce tension to the optimal level. In practice, since changing the production rate of insert 10 by onsite factory 5 is likely to be a slow and cumbersome operation, a more appealing fix may be to decrease the winding speed of winch 25, therefore reducing the linear speed of insert 10 in the pipeline

Conversely, FIG. 2B depicts a condition of relatively low tension, corresponding to relatively high sag. An appropriate fix would therefore be to increase the winding speed of winch 25 via control system 60, therefore increasing the linear speed of insert 10 in the pipeline.

The configuration of onsite factory 5 relative to pipeline 15, line 20, and winch 25, as shown in FIGS. 2A and 2B, reveals an important consideration. Ideally, insert 10 will exit onsite factory 5 and enter pipeline 15 readily, without requiring any lateral displacement or redirection. In the near-ideal situation of FIG. 2A, each of onsite factory 5, insert 10, and pipeline 15 are collinear, and minimal displacement or redirection of the insert is required. The situation deviates further from the ideal in FIG. 2B, due to the sag of insert segment 30. Insert 10 droops as it exits onsite factory 5, and will require elevation to enter pipeline 15. Unless properly mitigated with a device, such as rollers, the contact forces on the exit of factory 5 and the upstream opening of pipeline 15 have the potential of causing significant friction.

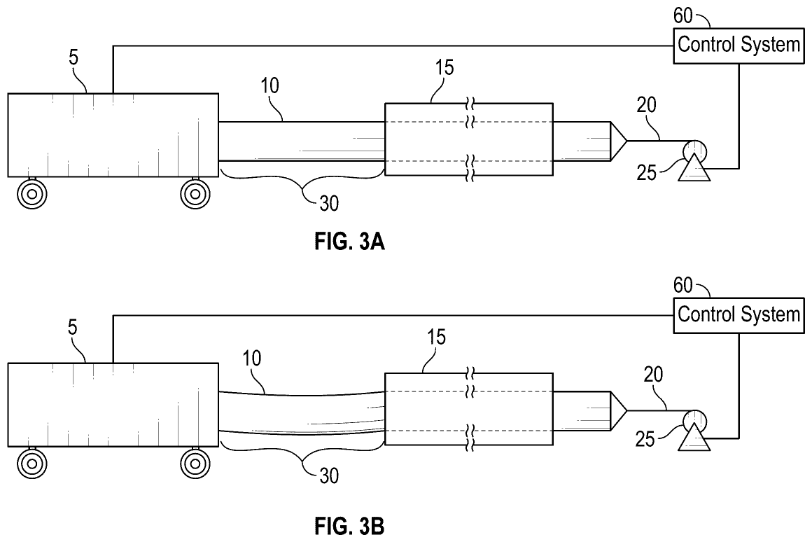

The same scenarios are depicted, from a lateral point of view, in FIGS. 3A and 3B, respectively. In this projection, the sag in insert segment 30 is more apparent.

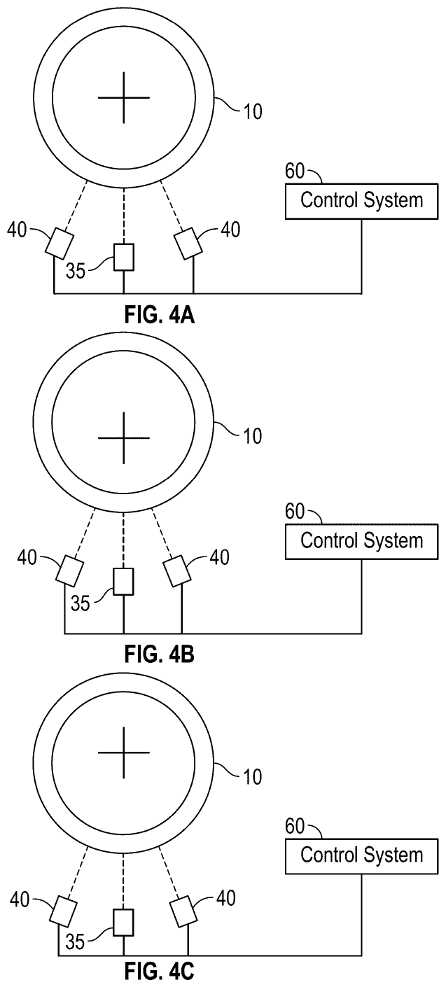

Depicted in FIGS. 4A-4C is an embodiment with three proximity sensors located in the sag zone. Insert 10 is shown in cross-section. A central proximity sensor 35, located under the centerline of the insert in the exemplary embodiment, is flanked by two inner peripheral proximity sensors 40. FIG. 4A shows the assembly of proximity sensors 35, 40 with the insert 10 at a neutral position. In this condition, the centroid of the insert 10 is shown with a crosshair. The beam emitted from each of the three proximity sensors 35, 40 is depicted with a dotted line. Due to the inward cant of inner peripheral proximity sensors 40, the three beams are not parallel, but rather are oriented to converge. In the absence of the insert 10, the beams would converge ( ) at a spot above the insert 10. The distances to the outer surface of the insert 10 reported by inner peripheral proximity sensors 40 will be different from the distance to the outer surface of the insert 10 reported by central proximity sensor 35, due both to the nonvertical beam trajectory and the curvature of insert 10.

FIG. 4B shows the effect of elevation of the insert 10, caused by decreased sag. The distance to the outer surface of the insert 10 reported by each of the three proximity sensors will necessarily increase. Likewise, FIG. 4C depicts the effect of increased sag on the geometry of the system, with shorter distances to the outer surface of the insert 10 being reported by each of the three proximity sensors.

In each of these configurations, the curvature of the insert 10 can be estimated from simple geometric considerations. This estimation can be useful for monitoring the fabrication process for the insert.

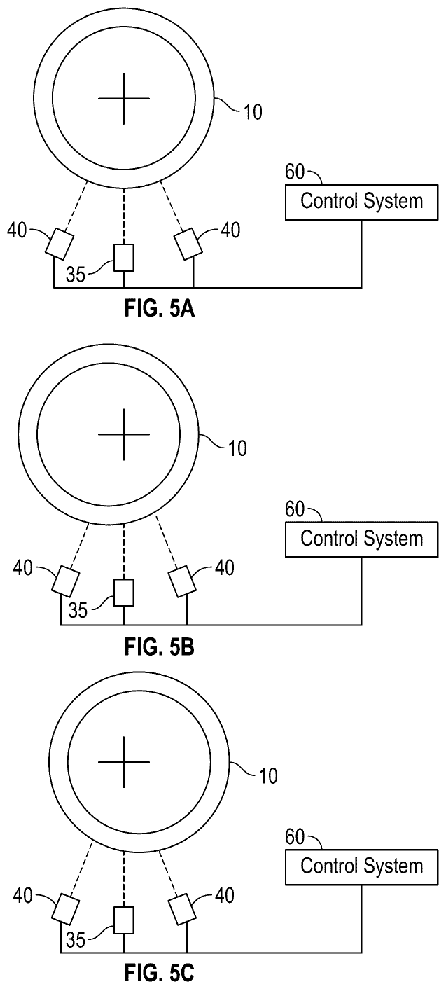

Lateral motion (sway) of the insert 10 is depicted in FIGS. 5A-5C, beginning with the assembly of proximity sensors 35, 40 with the insert 10 at a neutral position (no sway), as shown in FIG. 5A. Leftward motion of the insert 10, as shown in FIG. 5B, decreases the distance from the outer surface of the insert 10 to the left proximity sensor 40, and increases the distance from the outer surface of the insert 10 to the right proximity sensor 40. As shown in FIG. 5C, the opposite condition will hold for a rightward motion of the insert 10. In both cases, due to the curvature of the insert 10, the distance from the outer surface of the insert 10 to the central proximity sensor 35 will increase slightly.

The advantage of employing three proximity sensors will be apparent. A single proximity sensor may be adequate for inserts whose lateral motion is significantly smaller than their diameter. Likewise, correction for lateral motion of an insert may be possible with two proximity sensors. In the event that the insert diameter is subject to variation, the use of three proximity sensors will allow calculation of more robust estimates of sag and sway. This may be critical for installation of relatively inflexible inserts, for which small variations in sag can reflect a large variation in tension.

Suitable alignment of the proximity sensors 35, 40 will be determined by several factors, including the diameter of the insert 10 and the expected variation in both sag and sway in the insert 10. The assembly of proximity sensors 35, 40 should, on the one hand, provide useful and precise distance measurements. On the other hand, the proximity sensors 35, 40 should be positioned so as to accommodate larger excursions in sag or sway that might be anticipated.

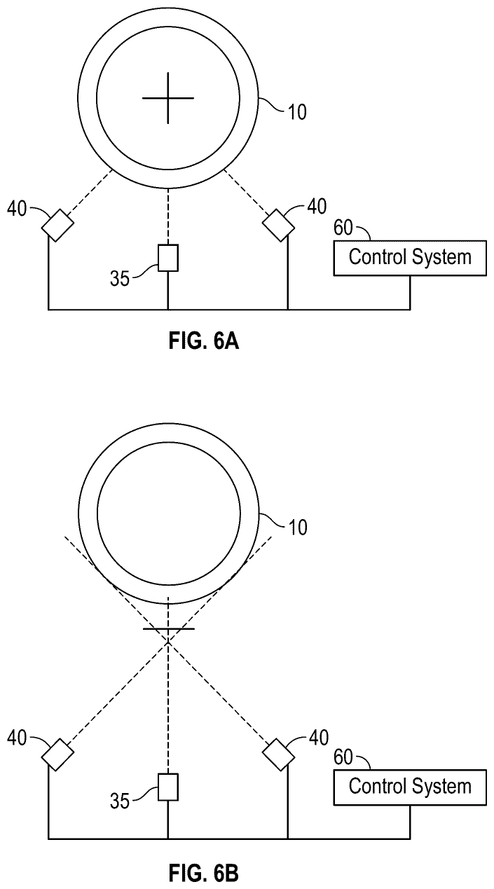

FIGS. 6A-6B depict a configuration with widely separated inner peripheral proximity sensors 40, each having a large inward cant. This configuration provides high precision to measurements of lateral sway, due to the large deviation of the beams from vertical. However, this configuration is vulnerable to overshooting or, as shown in FIG. 6B, undershooting the insert 10 upon large deviations in sag (with little to no sag/tight tension being shown in FIG. 6B).

To reduce the likelihood of over-or undershooting, for which distance information from both inner peripheral proximity sensors 40 would be lost, the proximity sensors 35, 40 can be aimed to converge at a location above the highest tolerable position for the insert 10, i.e., the position held by the insert when it is held most taut.

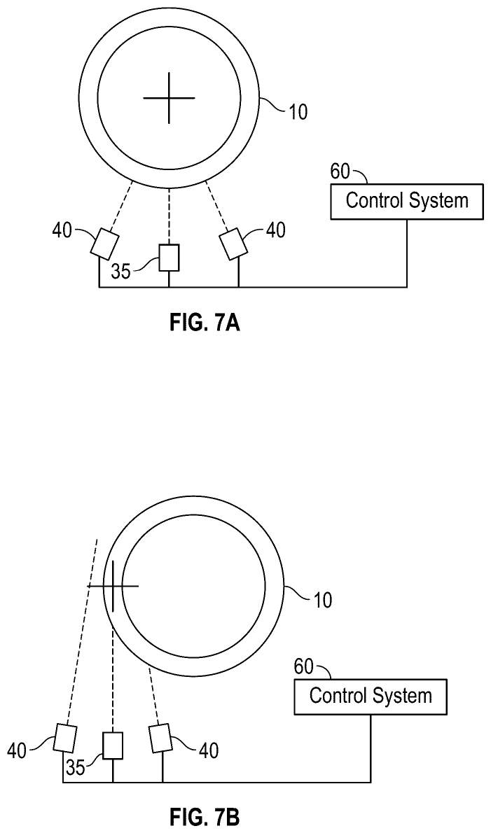

However, beams which are brought too close to parallel can cause difficulties with measurement of sway. In the limiting case of parallel beams, sway cannot be determined at all. FIG. 7A depicts a configuration with narrowly separated inner peripheral proximity sensors 40, each having a small inward cant. It will be apparent that this configuration will be less vulnerable to over- and undershoot than the configuration of FIGS. 6A-6B. However, as depicted in FIG. 7B, large lateral sway of the insert 10 may cause a peripheral proximity sensor 35, 40 with this configuration to miss its target.

It may be possible to compensate for excessive lateral sway. First, unlike the case of over- or undershooting the insert 10, the distance from only a single peripheral proximity sensor 40 is lost, absent extreme horizontal deviations from neutrality. Also, it can be expected that many lateral excursions have an oscillatory, “jump-rope” motion whose behavior can be modeled using well understood kinematics. Periodic loss of signal from a peripheral proximity sensor 40 can be accommodated in computations, particularly when deviations in insert diameter are relatively small. Finally, measurement of lateral deflection is intended to compensate for inaccurate determination of sag; relatively large inaccuracies in lateral deflection would be expected to give rise to more modest errors in determination of sag.

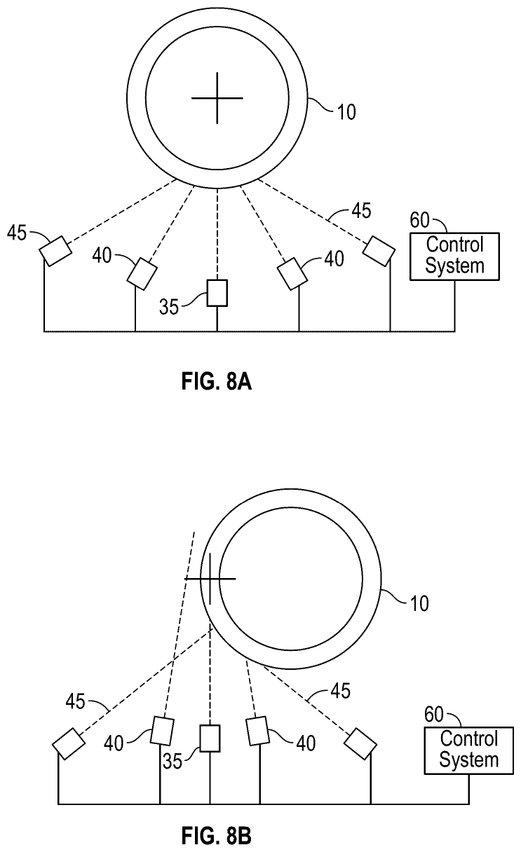

A more robust system can be envisioned containing five proximity sensors. An embodiment is depicted in FIGS. 8A-8B, with insert 10 in a neutral position in FIG. 8A and in a swayed position in FIG. 8B. This system contains central proximity sensor 35, two inner peripheral proximity sensors 40, and two outer peripheral proximity sensors 45. The system is highly tolerant of large lateral excursions, due to the high cant of outer peripheral proximity sensors 45. This can be seen in FIG. 8B, in which both of the outer peripheral proximity sensors maintain distance measurements, despite the high rightward sway.

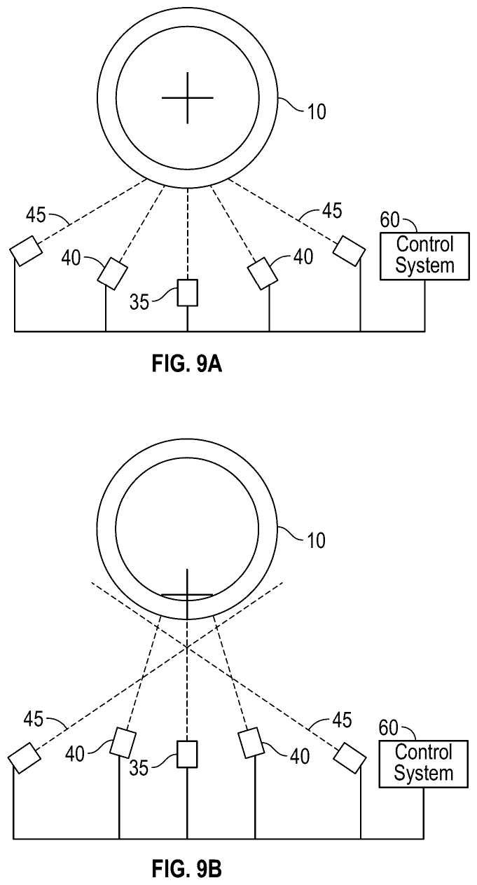

This hybrid system is likewise resistant to large deviations in sag. FIG. 9A depicts the same neutral position provided above. A large vertical deviation is shown in FIG. 9B. Because of their high cant, both outer peripheral proximity sensors 45 miss their targets; however, all three remaining proximity sensors 35, 40 continue to provide distance information.

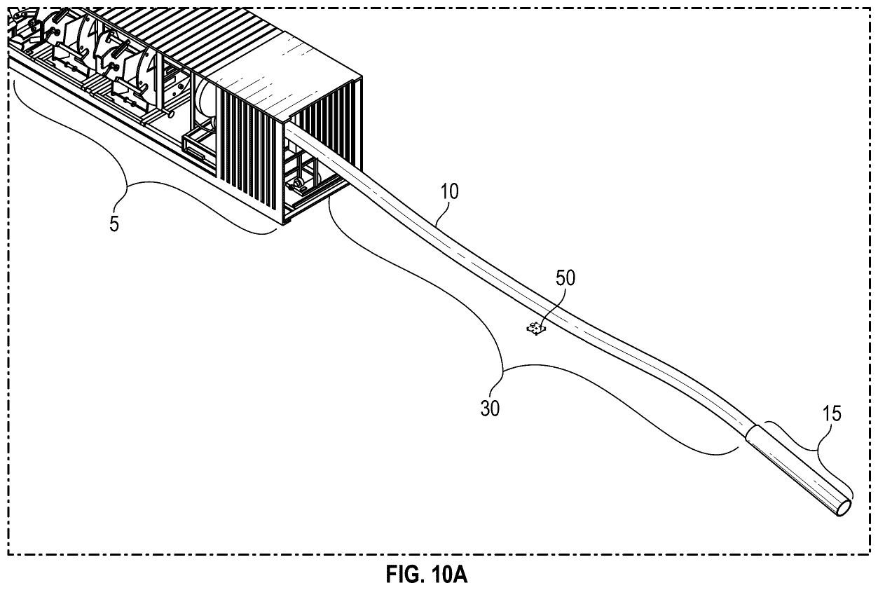

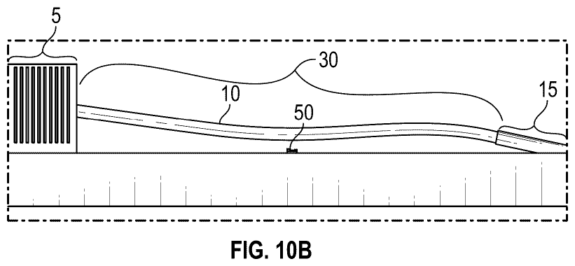

The disclosed concept is further illustrated in FIGS. 10A and 10B. Components depicted in these images include onsite factory 5, insert 10, pipeline 15, insert segment 30, and a sensor assembly 50 for housing/holding the proximity sensors 35, 40, and/or 45 as described herein. The sag is most readily apparent in FIG. 10B. In the illustrated embodiment. pipeline 15 is subterranean and remediation is therefore accomplished by feeding the insert 10 with an angle below horizontal.

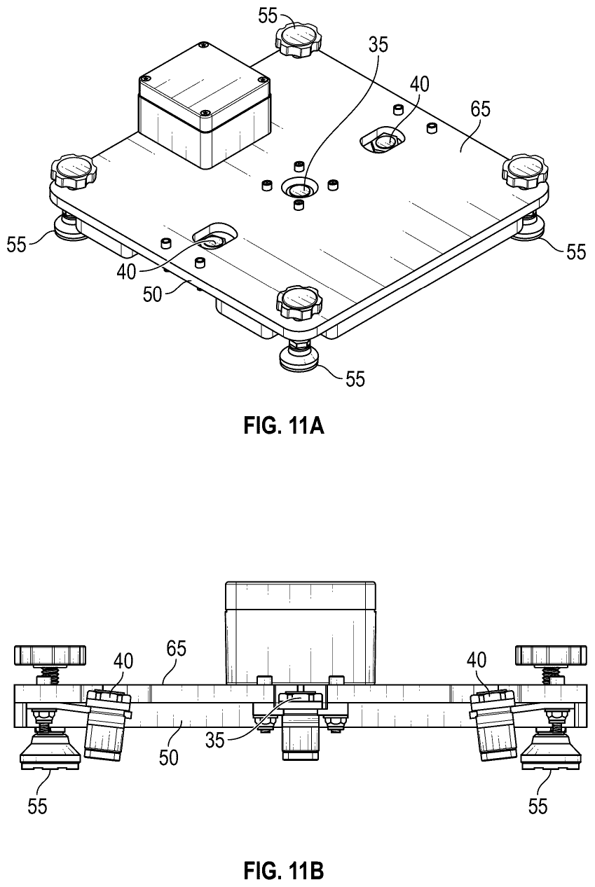

Sensor assembly 50 is depicted in more detail in FIGS. 11A and 11B. As seen in FIGS. 11A and 11B, sensor assembly 50 includes a base member 65. Adjustable legs 55 for controlling the alignment of sensor assembly 50 are coupled to base member 65. Proximity sensor 35, 40 (and/or 45, not shown) are coupled to base member 65 within holes provided therein as shown. In one particular embodiment, base member 65 is structured and configured to rotate on a horizontal axis parallel to the apparatus centerline or about qn axis peduncular to the apparatus centerline. In the perspective view shown FIG. 11A, insert (not shown) will cross sensor assembly 50 from top left to bottom right, crossing directly above central proximity sensor 35. The two peripheral proximity sensors 40 will flank the insert on either side. As seen in the horizontal projection of FIG. 11B, insert (not shown) will be perpendicular to the plane of the drawing, crossing directly above central proximity sensor 40.

While the methods and manufactures have described in detail and with reference to specific examples thereof, it will be apparent to one skilled in the art that various changes and modifications can be made therein without departing from the spirit and scope thereof.

What is claimed is:

1. A method for appointing a flexible insert into a pipeline, the pipeline having an upstream opening, a downstream opening, and an interior, the method comprising the steps of:
providing an onsite factory at or near the upstream opening of the pipeline, such that:
a sag zone is formed between an exit of the onsite factory and the upstream opening of the pipeline, and
a feed path is formed between the exit of the onsite factory and the downstream opening of the pipeline;
positioning one or more proximity sensors on or near a centerline between the exit of the onsite factory and the upstream opening of the pipeline;
forming a leading end for the insert in the onsite factory;
initiating manufacture of the insert in the onsite factory behind the leading end;
inserting the leading end for the insert into the upstream opening of the pipeline after initiating the manufacture of the insert;
continuing the manufacture of the insert behind the leading end;
advancing the leading end downstream in the interior of the pipeline while continuing the manufacture of the insert behind the leading end, thereby advancing the insert downstream along the feed path behind the leading end;
determining a degree of sag of a portion of the insert in the sag zone from data provided by the one or more proximity sensors as the insert is advanced downstream along the feed path, and
adjusting a speed of the advancing of the insert based on the determined degree of sag and a predetermined optimal sag range.

2. The method of claim 1, wherein the insert is advanced downstream with a line, said line comprising a first end and a second end, wherein the first end of the line is attached to the leading edge of the insert, further comprising the step of attaching the leading edge of the insert to the first end of the line.

3. The method of claim 2, wherein the second end of the line is attached to a winch located at or near the downstream end of the pipeline.

4. The method of claim 3, wherein a winding speed of the winch is adjustable, and wherein the adjusting the speed of the advancing of the insert comprises adjusting the winding speed of the winch.

5. The method of claim 1, wherein the one or more proximity sensors comprises a central proximity sensor located directly underneath the portion of the insert in the sag zone on the centerline.

6. The method of claim 5, wherein the central proximity sensor is configured to determine a distance to the portion of the insert in the sag zone in a direction that is substantially vertical.

7. The method of claim 6, wherein the one or more proximity sensors comprises one or more peripheral proximity sensors located off the centerline.

8. The method of claim 7, wherein the one or more proximity sensors comprises a first pair of peripheral proximity sensors, wherein:
each of the first pair of peripheral proximity sensors is located laterally outward from the centerline, in opposite directions; and
each of the first pair of peripheral proximity sensors is configured to determine a distance to the portion of the insert in the sag zone in a direction canted inward from vertical.

9. The method of claim 8, wherein the central proximity sensor and each of the first pair of peripheral proximity sensors are substantially collinear with a horizontal line that is perpendicular to the centerline.

10. The method of claim 9, wherein each of the first pair of peripheral proximity sensors is substantially the same distance from the central proximity sensor.

11. The method of claim 8, wherein the one or more proximity sensors further comprises a second pair of peripheral proximity sensors, wherein:
each of the second pair of peripheral proximity sensors is located laterally outward from the centerline, in opposite directions; and
each of the second pair of peripheral proximity sensors is configured to determine a distance to the portion of the insert in the sag zone in a direction canted inward from vertical.

12. The method of claim 11, wherein the central proximity sensor, each of the first pair of peripheral proximity sensors, and each of the second pair of peripheral proximity sensors are substantially collinear with a horizontal line that is perpendicular to the centerline.

13. The method of claim 12, wherein each of the second pair of peripheral proximity sensors is substantially the same distance from the central proximity sensor.

14. The method of claim 1, wherein the one or more proximity sensors are mounted on a support structure configured for positioning on a surface in the sag zone.

15. The method of claim 14, wherein the support structure is configured to rotate on a horizontal axis parallel to the centerline.

16. The method of claim 14, wherein the support structure is configured to rotate about an axis perpendicular to the centerline.

17. The method of claim 16, wherein the support structure is configured to rotate on a vertical axis perpendicular to the apparatus centerline.

18. The method of claim 1,
wherein upon determining that the degree of sag is below a lower optimal limit, the speed of the advancing of the insert is increased until the sag rises to a position above the lower optimal limit, and
wherein upon determining that the degree of sag is above the upper optimal limit, the speed of the advancing of the insert is decreased until the sag descends to a position below the upper optimal limit.

19. The method of claim 1, further comprising determining a degree of sway of the portion of the insert in the sag zone from data provided by the one or more proximity sensors and adjusting the speed of advancing also based on the determined degree of sway.

20. The method of claim 1, wherein the adjusting employs a closed loop control system to control the speed of the advancing of the insert based on the determined degree of sag and a predetermined optimal sag range.

21. The method of claim 1, wherein the adjusting the speed of the advancing of the insert comprises adjusting either or both of a feed speed of the insert or a speed at which the insert is drawn through the pipeline.

22. A system for appointing a flexible insert into a pipeline, the pipeline having an upstream opening, a downstream opening, and an interior, comprising:
an onsite factory structured and configured to manufacture the insert and to be positioned at or near the upstream opening of the pipeline, such that:
a sag zone is formed between an exit of the onsite factory and the upstream opening of the pipeline, and
a feed path is formed between the exit of the onsite factory and the downstream opening of the pipeline;
one or more proximity sensors positioned on or near a centerline between the exit of the onsite factory and the upstream opening of the pipeline; and
a control system, wherein the control system is structured and configured to:
cause the onsite factory to form a leading end for the insert in the onsite factory;
cause the onsite factory to initiate manufacture of the insert behind the leading end;
cause the onsite factory to continue the manufacture of the insert behind the leading end after the leading end for the insert is inserted into the upstream opening of the pipeline;
cause the system to advance the leading end downstream in the interior of the pipeline while the onsite factory continues the manufacture of the insert behind the leading end, thereby advancing the insert downstream along the feed path behind the leading end;
determine a degree of sag of a portion of the insert in the sag zone from data provided by the one or more proximity sensors as the insert is advanced downstream along the feed path, and
cause the system to adjust a speed of the advancing of the insert based on the determined degree of sag and a predetermined optimal sag range.

23. The system of claim 22, further comprising a winch and a line, wherein the line is attached to the leading edge of the insert and wherein a winding speed of the winch is adjustable, and wherein the control system is configured to adjust the speed of the advancing of the insert by adjusting the winding speed of the winch.

24. The system of claim 22, wherein the one or more proximity sensors comprises a central proximity sensor located directly underneath the portion of the insert in the sag zone on the centerline.

25. The system of claim 24, wherein the central proximity sensor is configured to determine a distance to the portion of the insert in the sag zone in a direction that is substantially vertical.

26. The system of claim 25, wherein the one or more proximity sensors comprises one or more peripheral proximity sensors located off the centerline.

27. The system of claim 26, wherein the one or more proximity sensors comprises a first pair of peripheral proximity sensors, wherein:
each of the first pair of peripheral proximity sensors is located laterally outward from the centerline, in opposite directions; and
each of the first pair of peripheral proximity sensors is configured to determine a distance to the portion of the insert in the sag zone in a direction canted inward from vertical.

28. The system of claim 27, wherein the central proximity sensor and each of the first pair of peripheral proximity sensors are substantially collinear with a horizontal line that is perpendicular to the centerline.

29. The system of claim 28, wherein each of the first pair of peripheral proximity sensors is substantially the same distance from the central proximity sensor.

30. The system of claim 27, wherein the one or more proximity sensors further comprises a second pair of peripheral proximity sensors, wherein:
each of the second pair of peripheral proximity sensors is located laterally outward from the centerline, in opposite directions; and
each of the second pair of peripheral proximity sensors is configured to determine a distance to the portion of the insert in the sag zone in a direction canted inward from vertical.

31. The system of claim 30, wherein the central proximity sensor, each of the first pair of peripheral proximity sensors, and each of the second pair of peripheral proximity sensors are substantially collinear with a horizontal line that is perpendicular to the centerline.

32. The system of claim 31, wherein each of the second pair of peripheral proximity sensors is substantially the same distance from the central proximity sensor.

33. The system of claim 22, wherein the one or more proximity sensors are mounted on a support structure configured for positioning on a surface in the sag zone.

34. The system of claim 33, wherein the support structure is configured to rotate on a horizontal axis parallel to the centerline.

35. The system of claim 33, wherein the support structure is configured to rotate about an axis perpendicular to the centerline.

36. The system of claim 33, wherein the support structure is configured to rotate on a vertical axis perpendicular to the apparatus centerline.

37. The system of claim 22, wherein the control system is configured such that:
upon determining that the degree of sag is below a lower optimal limit, the speed of the advancing of the insert is caused to be increased until the sag rises to a position above the lower optimal limit, and
upon determining that the degree of sag is above the upper optimal limit, the speed of the advancing of the insert is caused to be decreased until the sag descends to a position below the upper optimal limit.

38. The system of claim 22, wherein the control system is configured to determine a degree of sway of the portion of the insert in the sag zone from data provided by the one or more proximity sensors and to cause adjusting the speed of advancing also based on the determined degree of sway.

39. The system of claim 22, wherein the control system implements a closed loop control system to control the speed of the advancing of the insert based on the determined degree of sag and a predetermined optimal sag range.

40. The method of claim 22, wherein the speed of the advancing of the insert is adjusted by adjusting either or both of a feed speed of the insert or a speed at which the insert is drawn through the pipeline.

41. A method for appointing a flexible insert into a pipeline, the pipeline having an upstream opening, a downstream opening, and an interior, the method comprising the steps of:
inserting a leading end of the insert into the upstream opening of the pipeline;
advancing the leading end downstream in the interior of the pipeline, thereby advancing the insert downstream along the feed path behind the leading end;
determining a degree of sag of a portion of the insert in the sag zone from data provided by one or more proximity sensors positioned adjacent the insert as the insert is advanced downstream along the feed path, and
adjusting a speed of the advancing of the insert based on the determined degree of sag and a predetermined optimal sag range.

42. The method of claim 41, wherein the insert is advanced downstream with a line, said line comprising a first end and a second end, wherein the first end of the line is attached to the leading edge of the insert, wherein the second end of the line is attached to a winch located at or near the downstream end of the pipeline, and wherein a winding speed of the winch is adjustable, and wherein the adjusting the speed of the advancing of the insert comprises adjusting the winding speed of the winch.

43. The method of claim 41, wherein the one or more proximity sensors comprises a central proximity sensor located directly underneath the portion of the insert in the sag zone on the centerline, wherein the central proximity sensor is configured to determine a distance to the portion of the insert in the sag zone in a direction that is substantially vertical, and wherein the one or more proximity sensors comprises one or more peripheral proximity sensors located off the centerline.

44. The method of claim 43, wherein the one or more proximity sensors comprises a first pair of peripheral proximity sensors, wherein:
each of the first pair of peripheral proximity sensors is located laterally outward from the centerline, in opposite directions; and
each of the first pair of peripheral proximity sensors is configured to determine a distance to the portion of the insert in the sag zone in a direction canted inward from vertical.

45. The method of claim 44, wherein the one or more proximity sensors further comprises a second pair of peripheral proximity sensors, wherein:
each of the second pair of peripheral proximity sensors is located laterally outward from the centerline, in opposite directions; and
each of the second pair of peripheral proximity sensors is configured to determine a distance to the portion of the insert in the sag zone in a direction canted inward from vertical.

46. The method of claim 41, wherein the adjusting employs a closed loop control system to control the speed of the advancing of the insert based on the determined degree of sag and a predetermined optimal sag range.

47. The method of claim 41, wherein the adjusting the speed of the advancing of the insert comprises adjusting either or both of a feed speed of the insert or a speed at which the insert is drawn through the pipeline.
